(19) United States
(12) Patent Application Publication
(10) Pub. No.: US 2006/0195677 A1
(43) Pub. Date: Aug. 31, 2006

(54) Bank conflict avoidance in a multi-banked cache system

(75) Inventor: Teik-Chung Tan, Austin, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/068,548

(22) Filed: Feb. 28, 2005

(51) Int. Cl. G06F 12/10

(52) U.S. Cl. 711/205; 711/118

(57) ABSTRACT

A cache system comprises a plurality of cache banks, a translation look-aside buffer (TLB), and a scheduler. The TLB is used to translate a virtual address (VA) to a physical address (PA). The scheduler, before the VA has been completely translated to the PA, uses a subset of the VA's bits to schedule access to the plurality of cache banks.

### BACKGROUND

Cache memories are used in various microprocessor designs to improve performance by storing frequently used information. Performance is improved as information can be retrieved quicker from the cache, than from system memory, during program execution.

A superscalar processor may execute multiple read and write instructions in parallel. Such instructions typically require a cache that is configured to support multiple concurrent accesses. A multi-ported cache can be used, but often is not practical because such caches are physically too large for many applications. Many advanced processor designs implement multi-banked caches to enable parallel accesses to the cache. A multi-banked cache includes a plurality of banks of cache storage. However, multiple accesses are not permitted to the same bank at the same time in banks that are single-ported. Bank conflict detection logic is often used to prevent multiple, simultaneous accesses to the same bank. In some implementations, when a bank conflict is detected, the lower priority request is deferred in favor of the higher priority request.

Some types of caches use a translation look-aside buffer (TLB) to translate a virtual address to a physical address so that the physical address can be used to access one of the cache banks. Naturally, this translation process takes time (e.g., a clock cycle). Scheduling access to the multiple banks in a multi-bank cache generally takes into account the translated physical addresses. However, the competing desire for higher processor performance versus the time for the TLB translation to occur make it difficult to schedule access to the various banks in a multi-banked cache.

### SUMMARY

Various embodiments are disclosed to address one or more of issues noted above. In one embodiment, a cache system comprises a plurality of cache banks, a translation look-aside buffer (TLB), and a scheduler. The TLB is used to translate a virtual address (VA) to a physical address (PA). The scheduler, before the VA has been completely translated to the PA, uses a subset of the VA's bits to schedule access to the plurality of cache banks. These and other embodiments are disclosed herein.

### BRIEF DESCRIPTION OF THE DRAWINGS

For a detailed description of exemplary embodiments of the invention, reference will now be made to the accompanying drawings in which:

FIG. 1 shows a system comprising a cache subsystem in accordance with a preferred embodiment of the invention;

FIG. 2 shows a preferred embodiment of the cache subsystem; and

FIG. 3 shows an embodiment of a battery-operated communication device that comprises the cache subsystem of FIG. 1.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers broadly to a collection of two or more components and may be used to refer to an overall system as well as a subsystem within the context of a larger system. This disclosure also refers to “data” being stored in a cache. In this context and unless otherwise specified, “data” includes data, instructions, or both.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

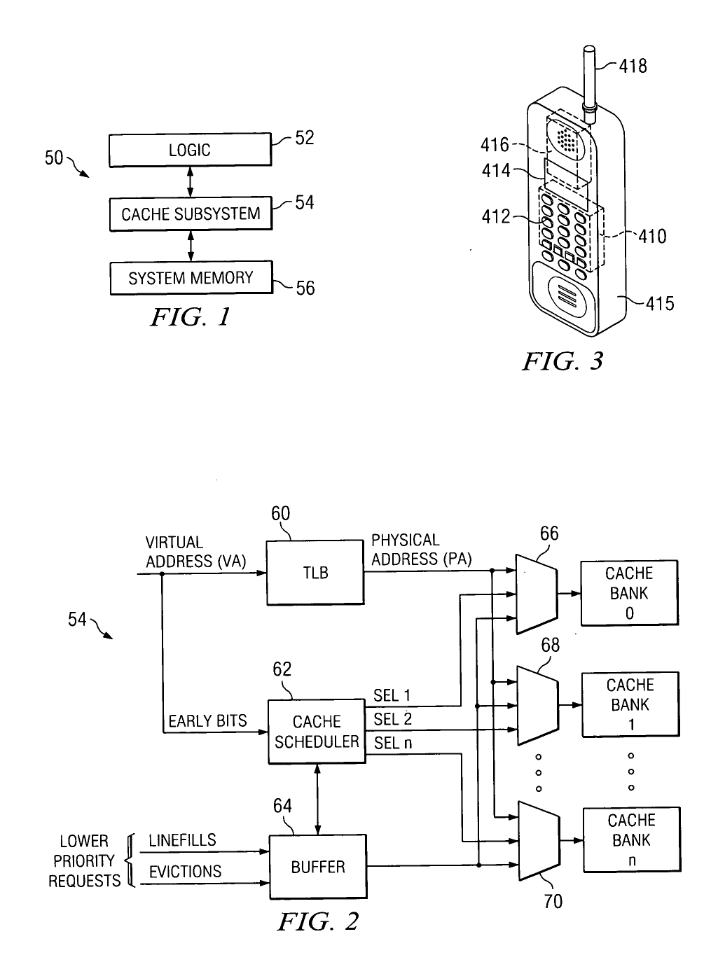

FIG. 1 shows a preferred embodiment of a system 50 comprising a logic unit 52, a cache subsystem 54, and system memory 56. In some embodiments, the system 50 may comprise a processor. If the system 50 comprises a processor, logic unit 52 preferably comprises instruction fetch logic, instruction decode logic, instruction execution logic, and other types of functional logic as desired.

The cache subsystem 54 and system memory 56 form a memory hierarchy. When the logic unit 52 requires access to a memory location, either due to a read or write transaction, the logic unit 52 first ascertains whether the target data is located in the cache subsystem 54. If the target data is located in the cache subsystem 54, then the read or write transaction accesses the cache subsystem to complete the transaction. If, however, the target data is not located in the cache subsystem 54, then the logic unit 52 or the cache subsystem 54 accesses the system memory 56 to access the target data. The target data may then be copied into the cache subsystem 54 for future use. Numerous types of cache architectures are possible. The cache subsystem 54 may be unified (i.e., adapted to store both instructions and data) or split (i.e., used to store instructions or data, but not both).

FIG. 2 illustrates a preferred embodiment of the cache subsystem 54. As shown, the cache subsystem 54 comprises a translation lookaside buffer (TLB) 60, a cache scheduler 62, a buffer 64, a plurality of cache banks (labeled in FIG. 2 as CACHE BANK 0, CACHE BANK 1, . . . , CACHE BANK n) and selection logic associated with each cache bank. In accordance with the preferred embodiment, each selection logic is implemented in the form of a multiplexer. Multiplexer 66 is used to provide a bank access to CACHE BANK 0, while multiplexers 68 and 70 are used to provide bank accesses to CACHE BANK 0 and CACHE BANK n, respectively. Any number of cache banks (preferably two or more) can be implemented in the cache subsystem 54 and is largely up to the system designer as would be well known to those of ordinary skill in the art.

Each cache bank preferably comprises a tag array and a data array. The tag array is ascertain whether there is a cache “bit” or “miss.” A hit means that the target data of a read or write request is already stored in the cache. A miss means that the target data is not already stored in the cache and must be pulled into the cache from elsewhere (e.g., system memory 56) if future use of the data from the cache is desired. The data array is used to store data and is generally is organized as a plurality of cache lines.

In accordance with the preferred embodiment, a virtual address (VA) is translated to a physical address (PA) by way of the TLB. The PA is then provided as an input to each of the multiplexers 66, 68, 70.

Various types of cache access requests are stored in the buffer 64 with physical addresses. Such requests may include, for example, lower priority requests (i.e., lower priority than read requests which could stall a pipeline if delayed). Examples of lower priority requests include linefills and evictions. A linefill request is performed as a result of cache miss to fill in a cache line in a cache bank with the target data from system memory 56. An eviction request is performed when the cache is full and new data needs to be stored in the cache. “Dirty” data (i.e., data that is different from that stored in system memory) in a cache line is written back to system memory 56 (i.e., evicted) to make room for the new data. Different or other types of requests may be stored as well in the buffer 64. No limitation is placed on the types of priority requests that are stored in buffer 64. One or more bank access requests from the buffer can be provided to an input of any one or more of the multiplexers 66, 68, 70. Thus, a PA from the TLB 60 and bank access requests from the buffer 64 are provided to the multiplexers 66-70.

The cache scheduler 62 provides a selection signal to each of the multiplexers. The SEL1 selection signal is provided to multiplexer 66, while the SEL2 and SELn selection signals are provided to multiplexers 68 and 70, respectively. The selection signal causes the corresponding multiplexer to provide one of its input signals as an output signal to the associated cache bank. Accordingly, the cache scheduler 62 controls the bank access request that is provided to each cache bank each time access requests are provided to the banks (e.g., each clock cycle).

In accordance with a preferred embodiment of the invention, one or more bits of the VA is provided to the cache scheduler 62 which uses those bits to schedule access to the various cache banks to avoid bank conflicts. The bits from the VA that are used by the scheduler 62 preferably are bits that are not needed for the translation process by the TLB to a PA. Various lower order bits of the VA are typically not used in the translation process. Such bits may comprise the “offset” of the VA. Within the offset, the lowest order bits of the VA (i.e., bits 0 through bit m) are used to select a target byte within a cache line. For example, if the cache line size is 64 bytes, then lowest 6 bits (bits 0 through bit 5) are used to select a specific byte within the cache line. Such byte selection bits are not used during the translation of the VA to a PA. One or more of the next lowest order bits that are still part of the offset, but higher order than the byte selection bits, are provided to, and used by, the cache scheduler 62 to select bank access requests that avoid bank conflicts. Because such bits are not used by the TLB 60 during the translation process, such bits can be used for the scheduling process in parallel (i.e., concurrently) with the VA-to-PA translation process. Such bits are referred to as “early” bits because they can be used during and prior to completion of the translation process.

The following represents an exemplary implementation. The following assumptions are made: (1) cache line size is 64 bytes, (2) there are 4 cache banks, (3) page size is 4K bytes, and (4) the virtual address size is 32 bits (bits 31:0). Based on these assumptions, the lowest order 12 bits of the VA represents the offset. Further, any of bits 6 to 11 can be used as the early bits by the scheduler 62. Because, in this example, there are four cache banks, only two bits are needed as the early bits. Thus, only two of bits 6 to 11 are needed. In a preferred embodiment, bits 6 and 7 are used as the early bits.

The cache scheduler 62 receives the early bits and determines the cache bank targeted by the VA that provided the early bits. The cache scheduler 62 also determines, from among the pending requests in buffer 64, the cache banks targeted by such requests. The cache scheduler can then schedule access to all cache banks in a manner that avoids bank conflicts. In so doing, the cache scheduler 62 can schedule around each PA so that other requests are scheduled without causing a conflict with the cache bank targeted by the PA. For example, if a particular PA targets CACHE BANK0, then the scheduler 62 can select bank accesses from buffer 64 that target cache banks other than CACHE BANK0. Further, the scheduling process is performed during and/or prior to completion of the VA-to-PA translation so that, upon completion of the translation, the resulting PA from the TLB 60 can be routed to its target cache bank. In some embodiments, the resulting PA from the TLB 60 can be routed to its target cache bank in the clock cycle immediately following the completion of the VA-to-PA translation. Alternatively stated, by the time the VA-to-PA translation has completed, the cache scheduler has already scheduled access to the various cache banks taking into account the cache bank that the PA will target. Moreover, not only are cache bank conflicts reduced or avoided, performance is increased by performing in parallel VA-to-PA translation and bank scheduling.

FIG. 3 shows an exemplary embodiment of a system containing the cache subsystem described above. The embodiment of FIG. 3 comprises a battery-operated, wireless communication device 415. As shown, the communication device includes an integrated keypad 412 and a display 414. The cache subsystem described above and/or the processor containing the above cache subsystem may be included in an electronics package 410 which may be coupled to keypad 412, display 414 and a radio frequency (“RF”) transceiver 416. The RF circuitry 416 preferably is coupled to an antenna 418 to transmit and/or receive wireless communications. In some embodiments, the communication device 415 comprises a cellular telephone.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A cache system, comprising:
a plurality of cache banks;
a translation look-aside buffer (TLB) which is used to translate a virtual address (VA) to a physical address (PA), the VA comprising a plurality of bits; and
a scheduler that, before the VA is completely translated to the PA, uses a subset of the VA's bits to schedule access to the plurality of cache banks.

2. The cache system of claim 1 wherein the subset of bits from the VA comprise bits that are not used in the translation of the VA to the PA.

3. The cache system of claim 1 wherein the subset of bits from the VA comprise bits from an offset of the VA.

4. The cache system of claim 1 wherein the scheduler schedules a PA for access to a cache bank upon completion of the translation in a next clock cycle following the completion of the translation.

5. The cache system of claim 1 further comprising a buffer into which cache requests are stored pending scheduling by the scheduler and wherein the scheduler uses the subset of the VA's bits to schedule access of at least one request from the buffer and a physical address to the cache banks in a next clock cycle following the completion of the translation.

6. A system, comprising:
logic that performs at least one of instruction fetching, instruction decoding and instruction execution;
system memory; and
a cache subsystem coupled to said logic and to said system memory, said cache subsystem comprising:
a plurality of cache banks;
a translation look-aside buffer (TLB) which is used to translate an virtual address (VA) to a physical address (PA), the VA comprising a plurality of bits; and
a scheduler that, before the VA is translated to the PA, uses a subset of the VA's bits to schedule access to the plurality of cache banks.

7. The system of claim 6 wherein the subset of bits from the VA comprise bits that are not used in the translation of the VA to the PA.

8. The system of claim 6 wherein the subset of bits from the VA comprise bits from an offset of the VA.

9. The system of claim 6 wherein the scheduler schedules a PA for access to a cache bank upon completion of the translation in a next clock cycle following the completion of the translation.

10. The system of claim 6 further comprising a buffer into which cache requests are stored pending scheduling by the scheduler and wherein the scheduler uses the subset of the VA's bits to schedule access of at least one request from the buffer and a physical address to the cache banks in a next clock cycle following the completion of the translation.

11. The system of claim 6 wherein the system comprises a system selected from a group consisting of a battery-operated communication device and a processor.

12. A method, comprising:
receiving a virtual address (VA);
translation said VA to a physical address (PA); and
while translating said VA to the PA, scheduling access to multiple banks in a multi-bank cache at least based on at least one bit from the VA.

13. The method of claim 12 wherein said scheduling access comprises scheduling access to multiple banks in a multi-bank cache at least based on a plurality of bits from the VA.

14. The method of claim 12 wherein said at least one bit is a bit that is not involved in translating said VA to the PA.

15. The method of claim 12 wherein said at least one bit is from an offset of the VA.
